(19) United States
(12) Patent Application Publication
(10) Pub. No.: US 2009/0229934 A1
(43) Pub. Date: Sep. 17, 2009

(54) Adjustable hydraulic damper for vehicles

(76) Inventor: Sheng-Fu Hung, Taichung County (TW)

Correspondence Address: Hung, Sheng-Fu, P.O. Box 44 - 2049, Taipei, 10668, TW

(21) Appl. No.: 12/073,848

(22) Filed: Mar. 11, 2008

(51) Int. Cl. F16F 9/14

(52) U.S. Cl. 188/314

(57) ABSTRACT

The present invention provides an adjustable hydraulic damper for vehicles, which enables the running vehicle to generate kinetic energy through the extrusion of piston and piston rod in the hydraulic damper, thus allowing for circulating supply of high-pressure oil and providing kinetic energy to the vehicles under the control of inlet and outlet check valves installed on both sides of the hydraulic damper.

### BACKGROUND OF INVENTION

(1). Field of the Invention

The present invention relates generally to an adjustable hydraulic damper for vehicles, and more particularly to an innovative one which allows for oil compression and output through the extrusion of piston and piston rod in the hydraulic damper, thus generating continuously kinetic energy for the vehicle applications.

(2). Description of the Prior Art

Various countries are making efforts to research and develop alternative energy resources owing to growing oil shortage and air pollution. And, the vehicles are also a major contributing factor to oil consumption. For this reason, the leading auto-manufacturers strive for R&D of new vehicles with alternative power sources, such as: LPG cars, diesel vehicles, hybrid vehicles, solar vehicles and hydrogen-powered vehicles, with major purpose of reducing oil consumption or minimizing environmental pollution and efficient energy conversion with other alternative energy resources.

However, due to poorer performance as compared with oil, the existing alternative energy resources are provided only as an auxiliary means, of which oil-electricity conversion is a preferred option. But, an improvement is required for converting the kinetic energy generated during the running process of vehicles into power supply.

### SUMMARY OF THE INVENTION

Thus, to overcome the aforementioned problems of the prior art, the inventor has provided an improved adjustable hydraulic damper for vehicles. With the kinetic energy generated from extrusion of piston and piston rod in the hydraulic damper, it allows for compression and output of oil by the hydraulic damper, and provides continuously power to the vehicles from kinetic energy generated by high-pressure oil.

The another purpose of the present invention is to enable circulating oil feed of oil tank based on the extrusion principle of piston and piston rod in the hydraulic damper, without the thrusting of any pump. Other than kinetic energy that's converted and supplied continuously to the vehicle components, it is possible to save the cost of the mechanism and increase its commercial value.

The other purpose of the present invention is to control the hydraulic damping and oil output via adjusting screws installed on the outlet valve. So, the operators could make quick adjustment, where applicable, to meet various operating requirements.

### BRIEF DESCRIPTION OF THE DRAWINGS

FIG. 1 shows a perspective view of the present invention.

FIG. 2 shows schematic view 1 of inlet and outlet operation of the present invention.

FIG. 3 shows schematic view 2 of inlet and outlet operation of the present invention.

FIG. 4 shows an application view of the present invention.

FIG. 5 shows a flow process diagram of the present invention.

### DETAILED DESCRIPTION OF THE INVENTION

The structural composition, technical means and efficacy of the present invention will be more readily understood with reference to the accompanying drawings.

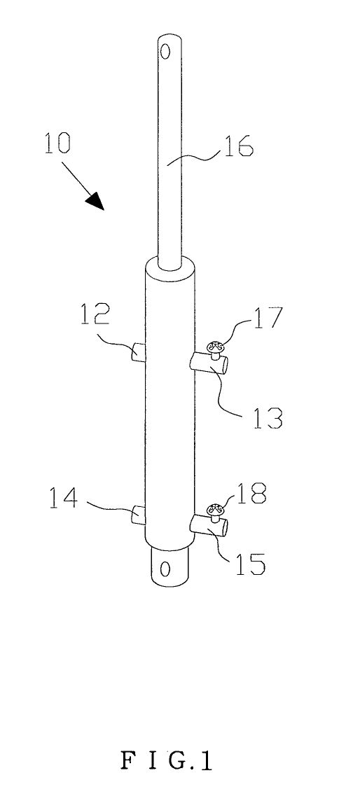

Referring to FIG. 1 (a perspective view), a set of inlet and outlet check valves 12, 13, 14, 15 are separately arranged at upper and lower sides of the hydraulic damper body 10; and the outlet valves 13, 15 are separately fitted with adjusting screws 17, 18; the piston 11 and piston rod 16 of hydraulic damper body 10 are shiftable linkage components.

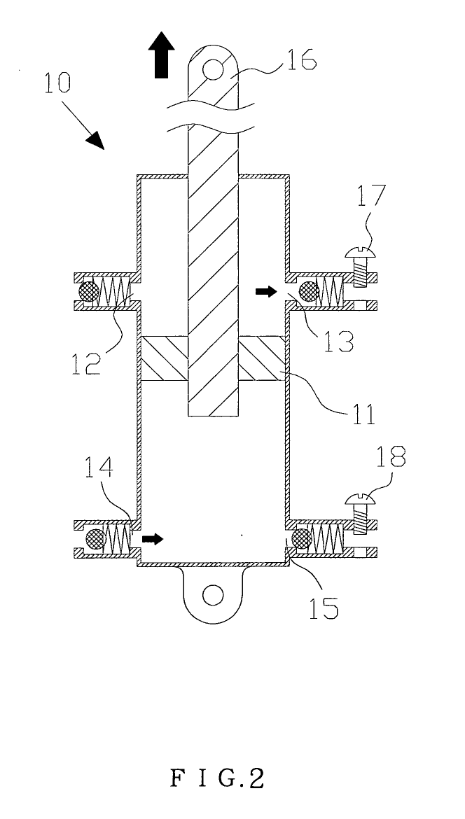

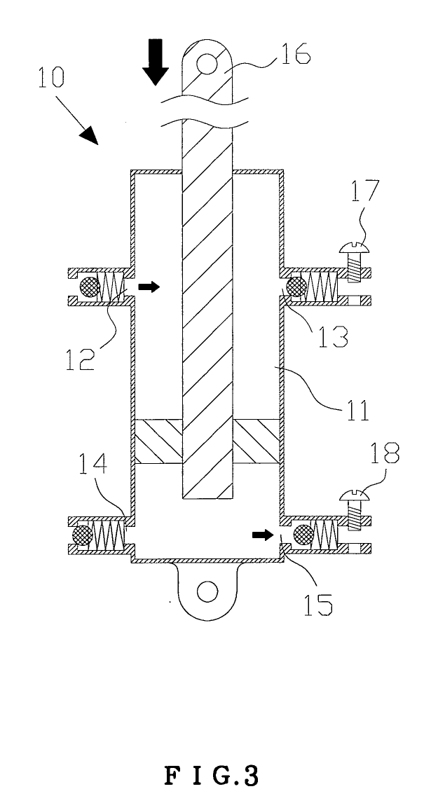

Referring to FIGS. 2 and 3 (schematic views of oil inlet and outlet), when the piston 11 and piston rod 16 of the hydraulic damper body 10 squeeze upwards, the upper inlet valve 12 and lower outlet valve 15 are in a closed state, the oil liquid is output if upper outlet valve 13 is opened, and then flows into hydraulic damper body 10 if the lower inlet valve 14 is opened simultaneously; conversely, when the piston 11 and piston rod 16 of the hydraulic damper body 10 squeeze downwards, the lower inlet valve 14 and upper outlet valve 13 are in a closed state, the oil liquid is output if lower outlet valve 15 is opened, and then flows into hydraulic damper body 10 if the upper inlet valve 12 is opened simultaneously; the oil liquid is pushed circularly based on the extrusion and drawing-thrusting principle of the piston 11 and piston rod 16; additionally, the adjusting screws 17, 18 on the upper and lower outlet valves 13, 15 are used to control the hydraulic damping and oil output of hydraulic damper body 10.

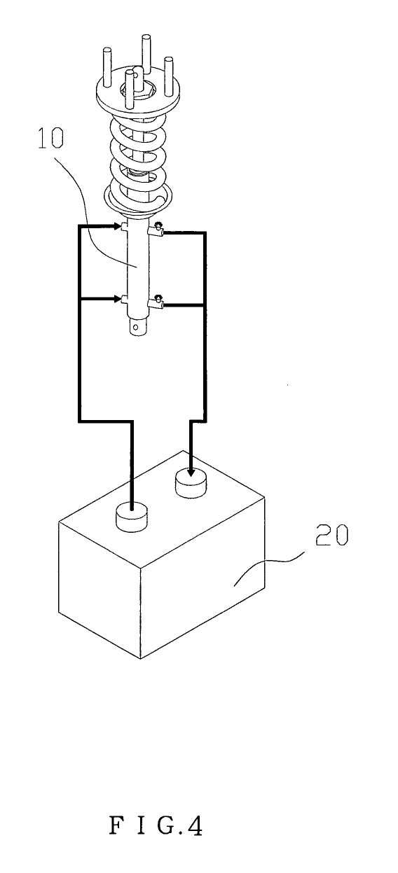

Referring also to FIG. 4(an application view of the present invention), the hydraulic damper body 10 is coupled with the oil tank 20, etc, via inlet and outlet check valves 12, 13, 14, 15 on the upper and lower sides.

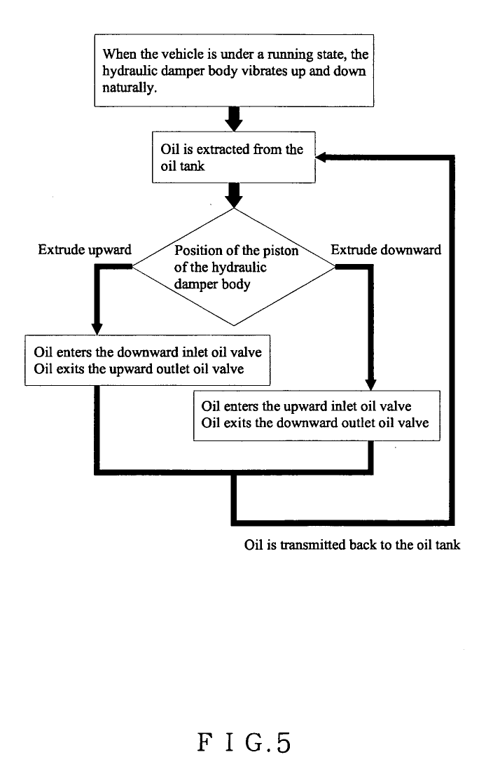

Referring to FIG. 5 (a flow process diagram) based on FIG. 4, the oil liquid in the oil tank 20 is compressed and output by the hydraulic damper body 10 through the extrusion of piston 11 and piston rod 16 of the hydraulic damper body 10, and then fed back circularly to the oil tank 20 after application; when the vehicle is under a running state, the kinetic energy generated by the hydraulic device could be provided continuously to the vehicles through the extrusion of piston 11 and piston rod 16 of the hydraulic damper body 10.

Although the invention has been explained in relation to its preferred embodiment, it is to be understood that many other possible modifications and variations can be made without departing from the spirit and scope of the invention as hereinafter claimed.

What is claimed is:

1. An adjustable hydraulic damper for vehicles, which comprising: a few hydraulic damper bodies, each of which is provided with a piston and piston rod; at least a set of inlet and outlet check valves along with adjusting screw are separately arranged at upper and lower sides of the hydraulic damper body 10, and connected to the oil tank and relevant linkage components;
with the reciprocating vertical shift of piston and piston rod in the hydraulic damper, the oil liquid in the oil tank is compressed and output by the hydraulic damper to generate kinetic energy for vehicle applications.

2. The device defined in claim 1, wherein the number of inlet and outlet check valves could be adjusted if necessary.

3. The device defined in claim 1, wherein adjusting screw for oil output control is arranged on the outlet check valve of the hydraulic damper body.
